(19) United States
(12) Patent Application Publication
(10) Pub. No.: US 2013/0021996 A1
(43) Pub. Date: Jan. 24, 2013

(54) METHOD FOR REDUCING INTERFERENCE UNDER MULTI-CARRIER CONFIGURATION

(71) Applicants: Hong Wang, Beijing (CN); Huarui Liang, Beijing (CN); Lixiang Xu, Beijing (CN)

(72) Inventors: Hong Wang, Beijing (CN); Huarui Liang, Beijing (CN); Lixiang Xu, Beijing (CN)

(73) Assignee: SAMSUNG ELECTRONICS CO., LTD., Suwon-si (KR)

(21) Appl. No.: 13/553,480

(22) Filed: Jul. 19, 2012

(30) Foreign Application Priority Data
Jul. 19, 2011 (CN) 201110209835.4
Sep. 29, 2011 (CN) 201110304849.4

(51) Int. Cl. H04W 72/04

(52) U.S. Cl. 370/329

(57) ABSTRACT

A number of methods reduce inter-cell interference under multi-carrier configuration. One of the methods includes a first NodeB transmitting, to a second NodeB, Primary Component Carrier (PCC) information or Primary cell (PCell) information configured by the first NodeB for a UE served by the first NodeB. The method also includes the second NodeB responding to the first NodeB. As such, when configuring CA for a UE served by the second NodeB, the second NodeB is able to configure the PCC information or PCell information for the UE served by the second NodeB according to the PCC information or PCell information indicated by the first NodeB.

### CROSS REFERENCE TO RELATED APPLICATION(S) AND CLAIM OF PRIORITY

The present application is related to and claims the benefit under 35 U.S.C. §119(a) of a Chinese patent application filed in the State Intellectual Property Office of the People's Republic of China on Jul. 19, 2011 and assigned Serial No. 201110209835.4 and a Chinese patent application filed on Sep. 29, 2011 and assigned Serial No. 201110304849.4, the entire disclosures of which are hereby incorporated by reference.

### TECHNICAL FIELD OF THE INVENTION

The present disclosure relates to radio communication techniques, and more particularly, to methods for reducing interference under a multi-carrier configuration.

### BACKGROUND OF THE INVENTION

FIG. 1 is a schematic diagram illustrating a system structure of System Architecture Evolution (SAE) according to the prior art. As shown in FIG. 1, User Equipment (UE) 101 is a terminal device used for receiving data. Evolved Universal Terrestrial Radio Access Network (E-UTRAN) 102 is a radio access network, including an eNodeB/NodeB which provides an interface for the UE to access the radio network. Mobility Management Entity (MME) 103 is responsible for managing mobility context, session context and security information of the UE. Serving Gateway (SGW) 104 is mainly used for providing a user plane function. The MME 103 and the SGW 104 may be in a same physical entity. Packet data network Gateway (PGW) 105 is responsible for charging, legal listening and other functions. The PGW 105 may also be in the same physical entity with the SGW 104. Policy and Charging Rule Function (PCRF) 106 provides QoS policies and charging rules. Serving GPRS Support Node (SGSN) 108 is a network device for providing route for data transmission in a Universal Mobile Telecommunications System (UMTS). Home Subscriber Server (HSS) 109 is a home sub-system of the UE, and is responsible for protecting user information such as current location, serving node location, user security information and packet data context of the user device.

In 3GPP Release 10 (also known as Rel-10), Carrier Aggregation (CA) is proposed. The CA is to aggregate two or more carriers to provide a large transmission bandwidth, such as up to 100 MHz bandwidth. The aggregated carriers are referred to as carrier components or component carriers. Hereinafter, descriptions are given with reference to component carriers.

In Rel-10, a UE can receive or transmit data on multiple component carriers at the same time. However, in Release 8 (also known as Rel-8) or Release 9 (also known as Rel-9), the UE is able to transmit and receive data on only one carrier.

It should be noted that, the above component carrier may include several consecutive carriers or several discontinuous carriers. The component carriers configured for the UE belong to the same eNB. The component carriers provide different coverage areas. When multiple component carriers are configured for the UE and each component carrier belongs to a different cell, one of the different cells provides information of NAS layer and encrypted information. This cell is referred to as a Primary Cell (PCell). The RRC connection establishment, RRC re-establishment and handover of the UE are all performed in the PCell. The remaining cells are referred to Secondary Cells (SCells). The carrier corresponding to a downlink direction of the PCell is referred to as a DL Primary Component Carrier (PCC). The carrier corresponding to an uplink direction of the PCell is referred to as a UL PCC. Generally, one PCell and multiple SCells may be configured for the UE. Signaling is transmitted in the PCell and data is transmitted in both the PCell and the SCell.

At present, under the CA configuration, the UE may be interfered with by other cells. For example, for a Pico NodeB, coverage areas of an eNodeB and the adjacent Pico NodeB are overlapped. If the eNodeB and the Pico NodeB configure the same PCell frequency for the UE they serve, co-frequency interference will make the UE of the Pico NodeB unable to receive signals of the cell normally. Therefore, it is a problem in Release 11 (also known as Rel-11) to reduce interference of other cells to the UE. It is a problem to be solved by the present disclosure.

### SUMMARY OF THE INVENTION

To address the above-discussed deficiencies of the prior art, it is a primary aspect of the present disclosure to provide methods for reducing interference under multi-carrier configuration.

Embodiments of the present disclosure provide methods for reducing inter-cell interference under multi-carrier configuration, so as to reduce interference brought out by an adjacent cell to a UE under the multi-carrier configuration.

According to an embodiment of the present disclosure, a method for reducing inter-cell interference under the multi-carrier configuration is provided. The method includes transmitting, by a first NodeB, to a second NodeB, Primary Component Carrier (PCC) information or Primary cell (PCell) information configured by the first NodeB for a UE served by the first NodeB. The method also includes responding to the first NodeB by the second NodeB.

According to another embodiment of the present disclosure, a method for reducing inter-cell interference under the multi-carrier configuration is provided. The method includes transmitting, by a first NodeB, to a second NodeB, Primary Component Carrier (PCC) information or Primary cell (PCell) information. The method also includes responding to the first NodeB by the second NodeB, and transmitting, by the second NodeB, PCC information or PCell information to the first NodeB.

According to another embodiment of the present disclosure, a method for reducing inter-cell interference under the multi-carrier configuration is provided. The method includes transmitting, by a first NodeB, coverage area information of a cell of the first NodeB to a second NodeB. The method also includes responding to the first NodeB by the second NodeB.

According to another embodiment of the present disclosure, a method for reducing inter-cell interference under the multi-carrier configuration is provided. The method includes transmitting, by a first NodeB, coverage area information of a cell of the first NodeB to a second NodeB. The method also includes responding to the first NodeB by the second NodeB, and transmitting, by the second NodeB, coverage area information of a cell of the second NodeB to the first NodeB.

According to another embodiment of the present disclosure, a method for reducing inter-cell interference under the multi-carrier configuration is provided. The method includes transmitting, by a first NodeB, a high interference indication to a second NodeB when experiencing a high interference from a second NodeB. The method also includes reducing, by the second NodeB, the interference to the first NodeB and responding to the first NodeB.

According to another embodiment of the present disclosure, a method for reducing inter-cell interference under the multi-carrier configuration is provided. The method includes transmitting, by a first NodeB, to a second NodeB, available Primary Component Carrier (PCC) information or Secondary Component Carrier (SCC) information. The method also includes responding to the first NodeB by the second NodeB.

In embodiments of the present disclosure, a receiving NodeB refers to information indicated by a transmitting NodeB when scheduling/configuring a UE, so as to reduce inter-cell interference under multi-carrier configuration. For example, NodeB 2 does not configure CA for a UE served by NodeB 2 independently. NodeB 2 configures PCC information with little interference for the UE it serves according to the PCC information or PCell information indicated by the adjacent NodeB 1. As such, the interference brought out by the adjacent cell under the multi-carrier configuration to the UE is reduced.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a system architecture of SAE according to the prior art;

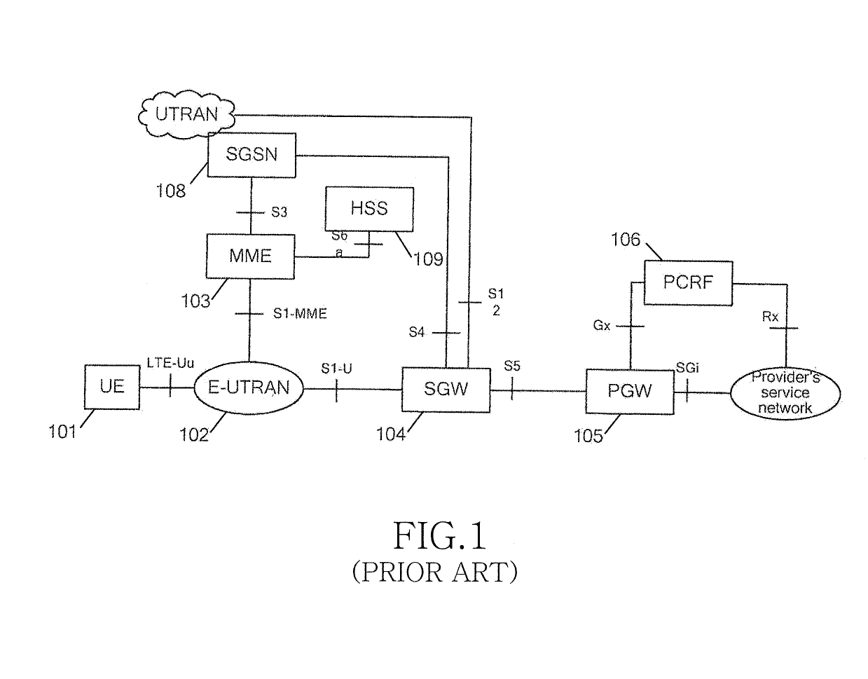

FIG. 2 illustrates a first method according to an embodiment of the present disclosure;

FIG. 3 illustrates a first embodiment of the present disclosure;

FIG. 4 illustrates CA configuration for a UE provided by the first embodiment of the present disclosure;

FIG. 5 illustrates a second embodiment of the present disclosure;

FIG. 6 illustrates a second method according to an embodiment of the present disclosure;

FIG. 7 illustrates a third embodiment of the present disclosure;

FIG. 8 illustrates a fourth embodiment of the present disclosure;

FIG. 9 illustrates a third method according to an embodiment of the present disclosure;

FIG. 10 illustrates a fourth method according to an embodiment of the present disclosure;

FIG. 11 illustrates a fifth embodiment of the present disclosure;

FIG. 12 illustrates a sixth embodiment of the present disclosure;

FIG. 13 illustrates a seventh embodiment of the present disclosure.

### DETAILED DESCRIPTION OF THE INVENTION

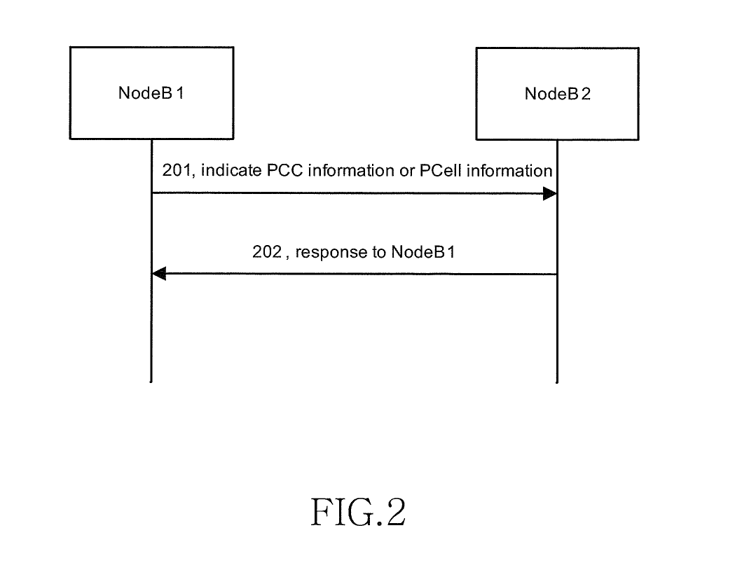

FIGS. 2 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged wireless communication system.

The present disclosure described hereinafter relates to methods for reducing interference under multi-carrier configuration.

The present disclosure will be described in further detail hereinafter with reference to accompanying drawings and embodiments to make the objective, technical solution and merits therein clearer.

Generally, a NodeB may have multiple frequencies. According to the method provided by the embodiments of the present disclosure, the frequencies of the NodeB may be divided into two parts. One part is assigned to a UE as one or more primary carriers and the other part is assigned to the UE as secondary carriers. In embodiments of the present disclosure, the NodeB may know, during the establishment of an X2 interface with an adjacent NodeB or during subsequent update procedure, which frequencies are assigned by the adjacent NodeB as the primary carriers. Then, the NodeB assigns primary carriers for the UE it serves according to the information obtained, so as to minimize the interference.

FIG. 2 is a flowchart illustrating a first method according to an embodiment of the present disclosure. As shown in FIG. 2, the method includes the following operations.

In Operation 201, NodeB 1 transmits primary carrier information or PCell information to NodeB 2. The primary carrier information or PCell information indicates information of the primary carrier/PCell that NodeB 1 will assign to a UE.

In Operation 202, NodeB 2 responds to NodeB 1.

In the first method, when scheduling/configuring a UE, NodeB 2 refers to the above primary carrier information/PCell information. For example, when configuring CA for the UE it serves, NodeB 2 configures primary carrier information or PCell information for the UE according to the primary carder information or PCell information indicated by NodeB 1.

Hereinafter, a number of embodiments will be given to describe the method shown in FIG. 2.

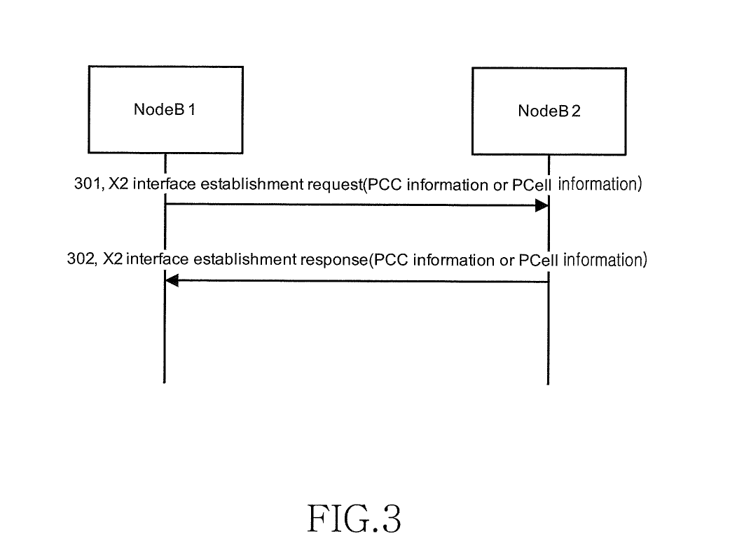

FIG. 3 is a flowchart illustrating the first embodiment of the present disclosure. As shown in FIG. 3, the flow includes the following operations.

In operation 301, after starting up, NodeB 1 determines that there is an adjacent cell. This cell belongs to another NodeB (denoted as NodeB 2). NodeB 1 establishes an X2 connection with NodeB 2. NodeB 1 transmits an “X2 interface establishment request” message to NodeB 2, requesting to establish an X2 interface with NodeB 2.

The process of how NodeB 1 finds the adjacent cell and NodeB 2 and determines whether to establish the X2 connection is known in the art and will not be described herein.

In operation 301, the “X2 interface establishment request” message includes an identifier of NodeB 1 and cell information of NodeB 1.

In one option of the first embodiment, the “X2 interface establishment request” message includes primary carrier information of NodeB 1, i.e. candidate carrier information of PCC. This information indicates which frequency or frequencies may be configured as the primary component carrier of the UE. When NodeB 1 configures CA for the UE it serves, the PCC configured for the UE is one of above indicated frequencies.

In another option of the first embodiment, the “X2 interface establishment request” message includes PCell information of NodeB 1. This information indicates which cell or cells can be configured as the PCell of the UE. When NodeB configures the PCell for the UE it serves, the PCell configured for the UE is one of the pcells indicated above.

Based on the above description, information elements in the X2 interface establishment request will be described in detail hereinafter with reference to Table 1 through Table 4 below.

TABLE 1

| Information element | Description |
|---|---|
| NodeB identifier | |
| 1 to maximum number of cells | |
| supported by the NodeB | |
| >cell physical identifier | |
| >cell identifier | |
| >cell routing code | |
| >operator identifier | |
| >uplink carrier frequency | |
| >uplink transmission bandwidth | |
| >downlink carrier frequency | |
| >downlink transmission bandwidth | |
| >primary component carrier | Indicate whether this carrier |
| indication | can be configured as primary |
| | component carrier of the UE |

TABLE 2

| Information element | Description |
|---|---|
| NodeB identifier | |
| 1 to maximum number of cells | |
| supported by the NodeB | |
| >cell physical identifier | |
| >cell identifier | |
| >cell routing code | |
| >operator identifier | |
| >uplink carrier frequency | |
| >uplink transmission bandwidth | |
| >downlink carrier frequency | |
| >downlink transmission bandwidth | |
| Primary carrier information | 0 to multiple |
| | Indicate which carriers |
| | can be configured as |
| | primary carriers of the UE. |
| | Multiple carriers may be |
| | configured as primary carriers |
| >uplink carrier frequency | |
| >downlink carrier frequency | |

TABLE 3

| Information element | description |
|---|---|
| NodeB identifier | |
| 1 to maximum number of cells | |
| supported by the NodeB | |
| >cell physical identifier | |
| >cell identifier | |
| >cell routing code | |
| >operator identifier | |
| >uplink carrier frequency | |
| >uplink transmission bandwidth | |
| >downlink carrier frequency | |
| >downlink transmission bandwidth | |
| >PCell indication | Indicate whether the cell |
| | can be configured as |
| | PCell of the UE |

TABLE 4

| Information element | Description |
|---|---|
| NodeB identifier | |
| 1 to the maximum number of cells | |
| supported by the NodeB | |
| >cell physical identifier | |
| >cell identifier | |
| >cell routing code | |
| >operator identifier | |
| >uplink carrier frequency | |
| >uplink transmission bandwidth | |
| >downlink carrier frequency | |
| >downlink transmission bandwidth | |
| PCell information | Indicate which cells |
| | can be configured as |
| | PCell of the UE |
| | Multiple cells may be |
| | configured as PCell of |
| | the UE |
| >cell identifier | |

In operation 302, NodeB 2 transmits an “X2 interface establishment response” message. The “X2 interface establishment response” message includes an identifier of NodeB 2, cell information of NodeB 2, and primary component carrier information or PCell information of NodeB 2. The format of the message may be any one of the formats shown in Table 1 through Table 4.

Both the “X2 interface establishment request” message in operation 301 and the “X2 interface establishment response” message in operation 302 may include the PCC information or the PCell information. In some embodiments, only one of the two messages includes the PCC information or the PCell information. The PCC information or the PCell information adopts any format as shown in Table 1 through Table 4.

In FIG. 3, NodeB 1 initiates the establishment of the X2 interface. It is also possible to initiate the establishment of the X2 interface by NodeB 2. The detailed process is similar to the above.

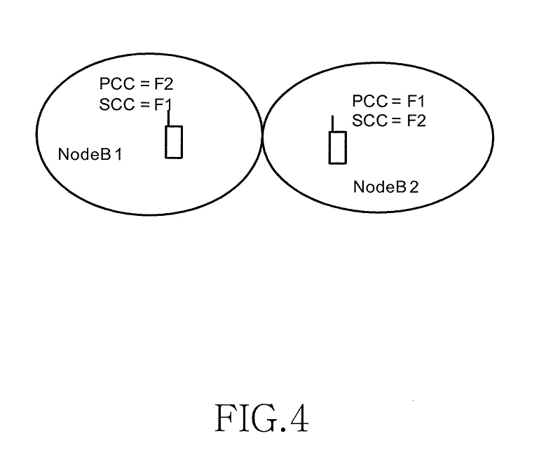

Hereinafter, suppose that NodeB 1 initiates the X2 interface establishment and transmits the “X2 interface establishment request” message to NodeB 2. The reduction of inter-cell interference between NodeB 1 and NodeB 2 (i.e., how to select PCC/PCell for the UE) is described with reference to FIG. 4. In the “X2 interface establishment request” message transmitted by NodeB 1, two cells, Cell-1 and Cell-2 deployed on NodeB 1 are indicated. Their frequencies are respectively F1 and F2. The “X2 interface establishment request” message further indicates which cells can be configured as a PCell of the UE, or indicates which frequencies can be configured as the PCC of the UE.

Accordingly, when NodeB 1 configures PCell for the UE (denoted as UE1) served by NodeB 1, NodeB 1 selects one cell from the PCells indicated by the “X2 interface establishment request” message as the PCell of UE1. Alternatively, when configuring the PCC for UE1, NodeB 1 selects one PCC from the PCCs indicated by the “X2 interface establishment request” message as the PCC of UE1.

When configuring a PCell for a UE (denoted as UE2) served by NodeB 2, NodeB 2 determines from the “X2 interface establishment request” message the PCell information or PCC information configured by NodeB 1 for UE1. In order to reduce interference, NodeB 2 configures a different frequency for UE2 as the PCC of UE2. Thus, co-frequency interference between NodeB 1 and NodeB 2 can be reduced.

In embodiments of the present disclosure, NodeB 2 may also receive the “X2 interface establishment response” message transmitted by NodeB 1, where the “X2 interface establishment response” message includes information about which PCC (or PCell) is configured by NodeB 1 for UE1 as the PCC (or PCell) of UE1. Accordingly, NodeB 2 may select the PCC according to a similar method as above.

The above disclosure describes a method for reducing inter-cell interference. A NodeB indicates PCell information (or PCC information) to another NodeB. The NodeB which receives the information schedules or configures the UE according to the information received. During the establishment of the X2 interface, if two NodeBs have indicated the PCell information (or PCC information) to each other, the information indicated by the two NodeBs may be the same. In this situation, interference cannot be reduced. It is possible to configure system elements such that only one NodeB indicates PCell information (or PCC information) to the other NodeB, or one of the NodeBs re-configures or re-selects PCell information (or PCC information) and then notifies the adjacent NodeB. The re-configuration process may be as shown in the following second embodiment.

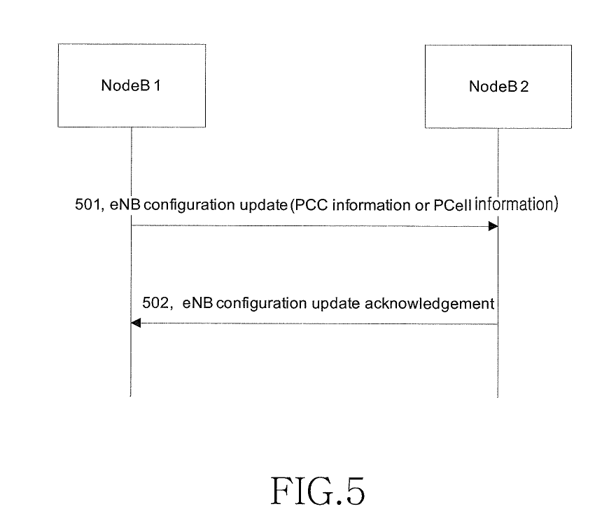

FIG. 5 is a flowchart illustrating a second embodiment of the present disclosure. As shown in FIG. 5, the flow includes the following operations.

In operation 501, NodeB 1 determines to add a new frequency or determines to modify previous configuration information. NodeB 1 transmits an eNB configuration update message to an adjacent NodeB 2.

The eNB configuration update message includes information of the newly-added (or modified) cell, and includes PCC information (i.e., candidate carrier information of the PCC), which indicates which carrier or carriers can be configured as the primary component carrier of the UE served by NodeB 1. When NodeB 1 configures CA for the UE, the PCC of the UE is one of those indicated by the PCC information.

Alternatively, the eNB configuration update message indicates PCell information, which indicates which PCell or PCells can be configured as the PCell of the UE. When NodeB 1 configures PCell for the UE, the PCell of the UE is one of those indicated by the eNB configuration update message.

Cell information in the eNB configuration update message may be in any format shown in Table 1 through Table 4.

In operation 502, NodeB 2 transmits an eNB configuration update acknowledgement.

In the second embodiment, the process in which NodeB 1 or NodeB 2 configures CA for the UE they serve is similar to the configuration process in the first embodiment and will not be repeated herein.

In some embodiments, NodeB 1 or NodeB 2 may also indicate SCC/SCell information. Through replacing the PCC or PCell by SCC or SCell in the first and second embodiments, the exchange of SCC/SCell information is realized.

The above disclosure describes the first method of the present disclosure. Hereinafter, a second method will be described.

A NodeB may have multiple frequencies/cells. These frequencies may have different coverage areas. The coverage area of the NodeB may be associated with different expressions. For example, the coverage area of the NodeB is related to a maximum transmission power used by the NodeB on the frequency. The coverage area of the NodeB may also be expressed as radius information of the cell. Or, cells may be classified into several categories according to size. An embodiment of the present disclosure provides another method which enables the NodeB to know the coverage area of an adjacent NodeB when establishing an X2 interface with the adjacent NodeB or during subsequent update procedure. A receiving NodeB schedules or configures the UE according to the information indicated by the adjacent NodeB, so as to reduce the inter-cell interference.

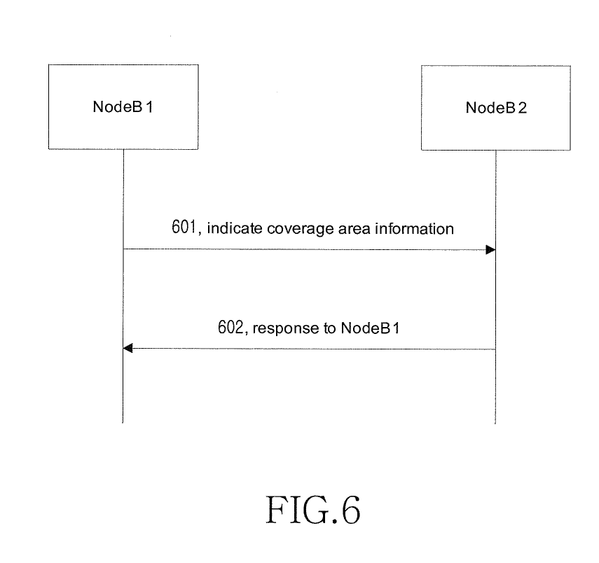

FIG. 6 is a flowchart illustrating the second method of the present disclosure. As shown in FIG. 6, the flow includes the following operations.

In operation 601, NodeB 1 transmits coverage area information of a cell of NodeB 1 to NodeB 2.

In operation 602, NodeB 2 responses to NodeB 1. In operation 602, NodeB 2 may also indicate coverage area information of a cell of NodeB 2 to NodeB 1.

NodeB 1 and NodeB 2 are adjacent NodeBs. A receiving NodeB schedules or configures the UE by referring to the coverage area of the cell of a transmitting NodeB. For example, when configuring CA for the UE of NodeB 2, NodeB 2 configures PCC or PCell information for the UE according to the coverage area indicated by the adjacent NodeB 1.

Hereinafter, the method shown in FIG. 6 will be described in detail with reference to two embodiments.

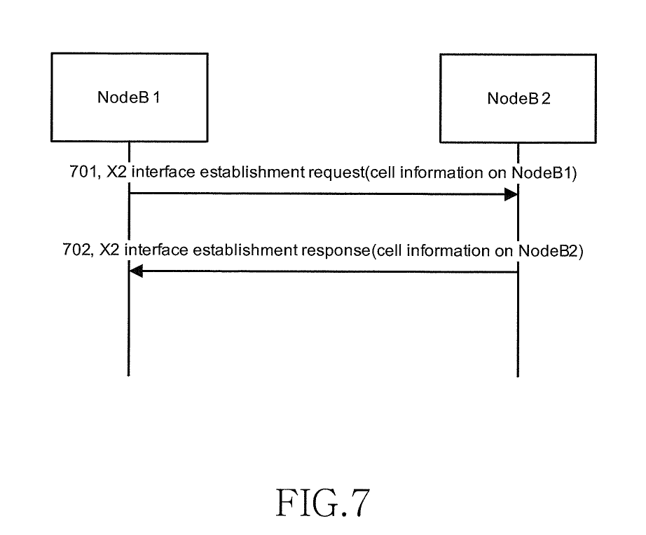

FIG. 7 is a flowchart illustrating the third embodiment of the present disclosure. As shown in FIG. 7, the flow includes the following operations.

In operation 701, NodeB 1 determines that there is an adjacent cell after starting up. The adjacent cell belongs to another NodeB (denoted as NodeB 2). NodeB 1 establishes an X2 connection with NodeB 2. NodeB 1 transmits an “X2 interface establishment request” message to NodeB 2, requesting to establish an X2 interface with NodeB 2.

In operation 701, NodeB 1 and NodeB 2 are adjacent NodeBs. The process in which NodeB 1 locates the adjacent cell and NodeB 2 and determines whether to establish the X2 connection in known in the art and will not be described herein.

In operation 701, the “X2 interface establishment request” message includes an identifier of NodeB 1, and cell information on NodeB 1. The cell information includes a cell identifier, uplink and downlink frequencies, and bandwidths of the cell. The cell information further includes coverage area information. According to different implementations, the coverage area information may be expressed in one of the following three manners.

In a first manner, the “X2 interface establishment request” message further indicates a maximum transmission power of the cell.

In a second manner, the “X2 interface establishment request” message further indicates a radius of the cell.

In a third manner, the “X2 interface establishment request” message further indicates size information of the cell, e.g. very small, small, medium, and large.

In operation 702, NodeB 2 transmits an “X2 interface establishment response” message. The “X2 interface establishment response” message includes an identifier of NodeB 2, and cell information on NodeB 2. The cell information includes a cell identifier, uplink and downlink frequencies, and bandwidths. In some embodiments, the “X2 interface establishment response” message further includes coverage area information. According to different implementations, the coverage area information may be expressed in one of the following three manners.

In a first manner, the “X2 interface establishment response” message further indicates a maximum transmission power of the cell.

In a second manner, the “X2 interface establishment response” message further indicates a radius of the cell.

In a third manner, the “X2 interface establishment response” message further indicates size information of the cell, e.g. very small, small, medium and large.

It can be seen that, in FIG. 7, NodeB 1 initiates the establishment of the X2 interface. In some embodiments, NodeB 2 may also initiate the establishment of the X2 interface. The detailed process is substantially the same and will not be described herein.

When a data amount on NodeB 1 or NodeB 2 (NodeB 2 is taken as an example) is added, the NodeB determines to arrange a new frequency. Currently, there are multiple deployment methods. Hereinafter, the deployment methods are described.

Suppose there are two component carriers, F1 and F2. There are several CA deployment scenarios.

In a first deployment method, the component carriers have the same position and are overlapped. The coverage areas of the component carriers are basically the same. Both of the component carriers can be configured as PCell and support movement process. Generally, F1 and F2 are in the same band, e.g. 2 GHz, 800 MHz.

In a second deployment method, the component carriers have the same position and are overlapped. But the coverage area of F2 is relatively small. Only F1 provides an enough coverage area. F2 is used to improve data throughput. Only F1 supports the movement process. F1 and F2 may be in different bands, e.g., F1={800 MHz, 2 GHz} and F2={3.5 GHz }.

In a third deployment method, the component carders have the same position. F2 antenna is directed to a cell edge of F1 to improve cell edge throughput. F1 provides enough coverage but F2 may be discontinuous in coverage. Only F1 supports the movement process. F1 and F2 may be in different bands, e.g. F1={800 MHz, 2 GHz} and F2={3.5 GHz}.

In a fourth deployment method, F1 provides enough coverage but F2 is only deployed in hot spots. Only F1 supports the movement process. F1 and F2 may be in different bands, e.g. F1={800 MHz, 2 GHz} and F2={3.5 GHz}.

A fifth deployment method is similar to the second deployment method, but a frequency selective repeater is deployed to improve coverage of a carrier.

Based on the five deployment methods described above, when determining a deployment method, a NodeB selects a deployment method which has a smaller interference to the adjacent NodeB by referring to the coverage area information of the adjacent cell. As shown in FIG. 7, NodeB 2 has obtained the cell information on NodeB 1, including the cell frequency and the maximum transmission power. According to the information, NodeB 2 is able to deploy the new frequency optimally. For example, NodeB 2 determines to deploy a new frequency F2. The adjacent NodeB 1 has two cells, the frequency of cell 1 is F1 and the maximum transmission power of cell 1 is P1. The frequency of cell 2 is F2 and the maximum transmission power of cell 2 is P2. F1 and F2 belong to the same band. The maximum transmission power corresponding to F2 is larger than that corresponding to F1. NodeB 2 may determine that the coverage area of F2 of NodeB 1 is smaller than that of F1 and NodeB 1 belongs to the above second deployment method. Therefore, NodeB 2 may configure a relatively large coverage area for a new cell (frequency is F2). A large transmission power may be used and the first deployment method may be adopted.

When configuring or scheduling UE, the NodeB may refer to the coverage area information of the adjacent NodeB. The NodeB obtains the cell information on the adjacent NodeB, including the cell frequency and maximum transmission power. According to the information, the NodeB may select a proper primary carrier frequency for the UE, so as to reduce inter-cell interference. For example, suppose NodeB 2 has obtained the cell information on the adjacent NodeB 1 through the third embodiment as shown in FIG. 7. The adjacent NodeB 1 has two cells. The frequency of cell 1 is F1 and the maximum transmission power is P1. The frequency of cell 2 is F2 and the maximum transmission power is P2. F1 and F2 belong to the same band. The maximum transmission power corresponding to F2 is lower than that corresponding to F1. NodeB 2 is able to determine that the coverage area of F2 on the adjacent NodeB 1 is smaller than that of F1. NodeB 2 may configure the PCC of the UE at the edge of the cell as F2. Similarly, if NodeB 1 knows the cell frequency and maximum transmission power on the adjacent NodeB 2, NodeB 1 is also able to determine which frequency has a lower interference to the UE it serves. NodeB 1 may select a proper PCC for the UE it serves to reduce the interference.

When the NodeB deploys a new frequency or modifies the current cell information, the NodeB notifies the adjacent NodeB of the new configuration. A fourth embodiment describes the update procedure.

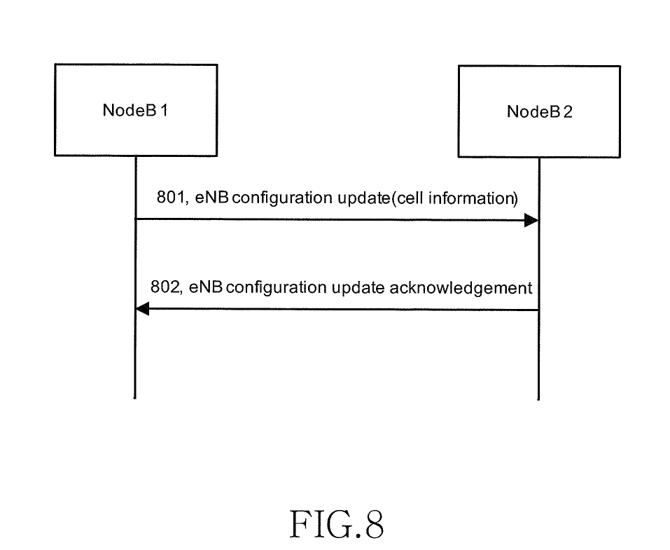

FIG. 8 is a flowchart illustrating the fourth embodiment of the present disclosure. As shown in FIG. 8, the flowchart includes the following operations.

In operation 801, NodeB 1 determines to add a new frequency or determines to modify previous configuration information. NodeB 1 transmits an “eNB configuration update” message to an adjacent NodeB 2. The “eNB configuration update” message includes an identifier of NodeB 1 and information of the newly added (or modified) cell. The eNB configuration update message further includes coverage area information. According to different implementations, the coverage area information may be expressed in one of the following three manners.

In a first manner, the “eNB configuration update” message further indicates a maximum transmission power of the cell, or the modified cell information including the maximum transmission power of the modified cell.

In a second manner, the “eNB configuration update” message further indicates a radius of the cell.

In a third manner, the “eNB configuration update” message further indicates size information of the cell, e.g. very small, small, medium and large.

In operation 802, NodeB 2 transmits an eNB configuration update acknowledgement.

In this embodiment, the process in which NodeB 1 or NodeB 2 configures the CA for the UE they serve is similar to that in the third embodiment and will not be repeated herein.

The second method is described above through the third and the fourth embodiments. Hereinafter, a third method provided by the present disclosure will be described.

A NodeB receives a measurement report of a UE. If there is a large interference from an adjacent NodeB on a certain frequency, the NodeB may request the adjacent NodeB to configure an Almost Blank Subframe (ABS). The adjacent NodeB does not use resources which are configured as ABS. These subframes are used by the NodeB requesting, the ABS. Thus, the interference can be reduced. But the defect of the method is that the subframe utilization ratio is low. For a NodeB with a high capacity, the number of subframes may not be enough. Accordingly, an embodiment of the present disclosure provides a method to improve subframe utilization ratio and reduce interference.

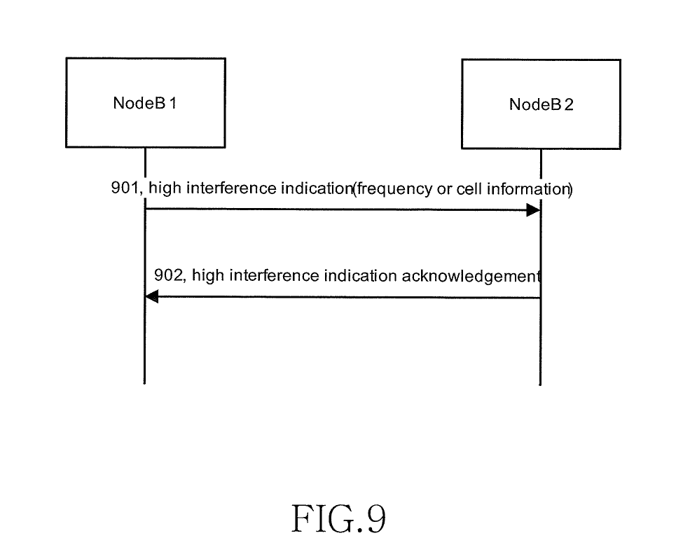

FIG. 9 is a flowchart illustrating a third method according to an embodiment of the present disclosure. As shown in FIG. 9, the method includes the following operations.

In operation 901, a frequency on NodeB 1 is substantially interfered by NodeB 2 (e.g., NodeB 1 experiences interference more than a predetermined amount). NodeB 1 transmits a “high interference indication” to NodeB 2.

The high interference indication may be an existing message or a new message. According to different implementations, the high interference indication may include any one of the following:

(1) An identifier of a cell affected by the high interference;

(2) Frequency information affected by the high interference.

(3) Frequency information affected by the high interference and an indication of whether the frequency is configured as a PCC of the UE served by NodeB 1.

(4) An identifier of the cell affected by the high interference, and an indication of whether the cell is configured as the PCell of the UE served by NodeB 1.

In addition to the above information, the high interference indication may further indicate the maximum transmission power corresponding to the frequency/cell.

In operation 902, after receiving the high interference indication, NodeB 2 reduces the interference to NodeB 1 and transmits a response message to NodeB 1. NodeB 2 may reduce the interference to NodeB 1 by (1) decreasing the transmission power of the frequency/cell suffered from the high interference indicated by NodeB 1, or (2) configuring another frequency which has little interference to NodeB 1 as the PCC of the UE it serves.

Hereinafter, a fourth method provided by the present disclosure will be described.

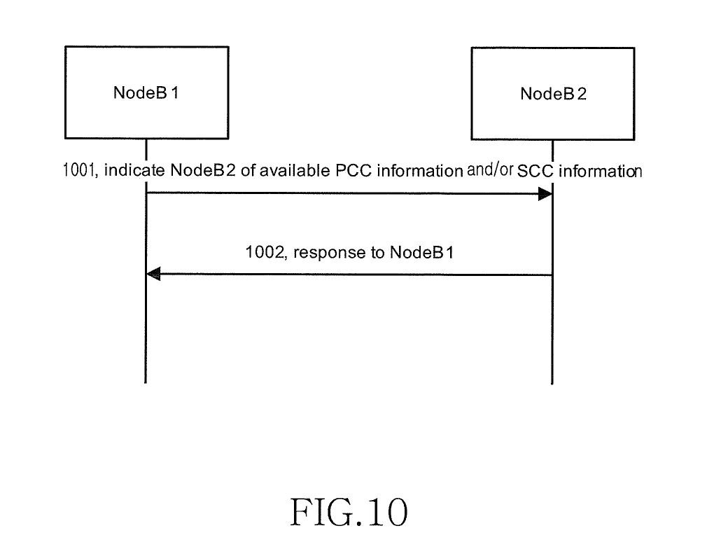

FIG. 10 is a flowchart illustrating the fourth method according to an embodiment of the present disclosure. As shown in FIG. 10, the method includes the following operations.

In operation 1001, NodeB 1 transmits a message to NodeB 2, indicating available PCC information and/or SCC information to NodeB 2.

In operation 1002, NodeB 2 transmits a response message to NodeB 1.

In the method, NodeB 2 refers to the available PCC information and/or SCC information indicated by NodeB 1 when scheduling/configuring the UE. For example, when configuring the CA for the UE it serves, NodeB 2 configures PCC information and/or SCC information according to the available PCC information and/or SCC information indicated by NodeB 1.

In addition, if a user of NodeB 1 moves close to NodeB 2, the user will be substantially interfered with by NodeB 2. Since NodeB 1 knows the available PCC information of NodeB 2, the user may be switched to a frequency different from the available PCC information of NodeB 2, so as to avoid the interference of NodeB 2. For example, suppose the available PCC of NodeB 2 is F1, NodeB 1 is configured with F1 and F2, and NodeB 1 configures F1 as the PCC of a UE (denoted as UE1) it serves. When UE1 moves close to NodeB 2, UE1 will be interfered by the frequency F1 of NodeB 2. In order to avoid the interference of NodeB 2 to UE1, NodeB 1 may switch the PCC of UE1 to another frequency (e.g., F2) through a switching, process according to the available PCC information of NodeB 2. Then, NodeB 1 configures some subframes for use of NodeB 2 according to the previously defined ABS scheme. NodeB 1 does not use these subframes. Thus, it is ensured that the PCC of NodeB 2 may be transmitted using, the maximum transmission power and the interference can be reduced. If NodeB 2 is a Pico cell, the above ABS configuration may be used by all Pico cells with frequency F1. NodeB 1 may transmit the ABS configuration to NodeBs of all Pico cells with frequency F1. Thus, the ABS configuration can be used by as many cells as possible.

In the present disclosure, NodeB 2 may also configure different maximum transmission powers for different frequencies according to the indication of NodeB 1. For example, it is possible to configure system elements such that the maximum transmission power of the PCC of NodeB 2 indicated by NodeB 1 is the largest and larger than the maximum transmission powers of other frequencies. Thus, it is ensured that signal energy of the PCC of NodeB 2 received by users of NodeB 2 is relatively large. According to the signal energy reported by the user, NodeB 2 is able to configure the PCC of the user as one of the PCCs indicated by NodeB 1.

Hereinafter, the method shown in FIG. 10 will be described in detail with reference to a fifth embodiment through a seventh embodiment.

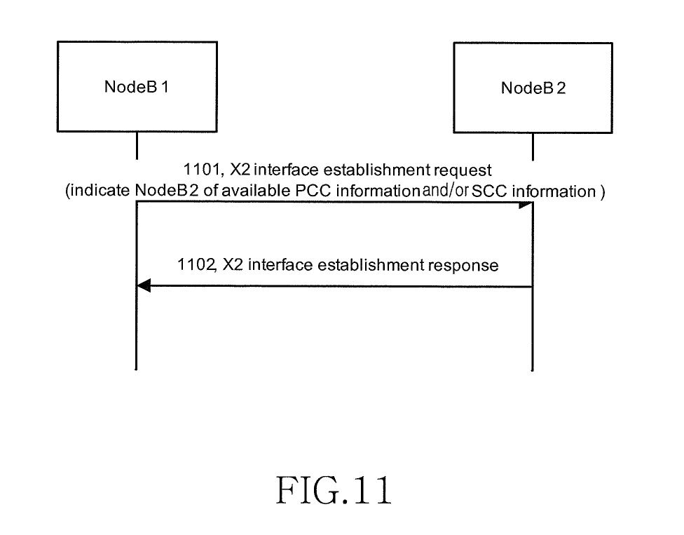

FIG. 11 is a flowchart illustrating the fifth embodiment of the present disclosure. As shown in FIG. 11, in the flow, NodeB 1 is a macro NodeB, NodeB 2 is a Pico NodeB. Based on this, as shown in FIG. 11, the flow may include the following operations.

In operation 1101, NodeB 1 locates an adjacent cell and the adjacent cell belongs to another NodeB (denoted as NodeB 2). NodeB 1 establishes an X2 connection with NodeB 2. In particular, NodeB 1 transmits an “X2 interface establishment request” message to NodeB 2, requesting to establish an X2 interface with NodeB 2.

In operation 1101, the process in which NodeB 1 finds the adjacent cell and determines whether to establish the X2 connection are known in the art and will not be repeated herein.

In operation 1101, the “X2 interface establishment request” message includes an identifier of NodeB 1 and cell information on NodeB 1.

In one option of the fifth embodiment, the “X2 interface establishment request” message further includes the following information: available PCC information and/or available SCC information of NodeB 2.

The available PCC information of NodeB 2 (i.e., candidate carrier information of NodeB 2) indicates which frequency or frequencies can be configured as the PCC of the UE. As such, when configuring the CA for the UE served by NodeB 2, NodeB 2 configures one of the indicated PCCs for the UE. The PCC information may be expressed by a cell identifier or a cell frequency.

The available SCC information of NodeB 2 indicates which frequency or frequencies can be configured as the SCell of the UE. When configuring the SCell for the UE served by NodeB 2, NodeB 2 configures one of the indicated SCCs as the SCell for the UE. The SCC information may be expressed by the cell identifier or the cell frequency.

In some embodiments, NodeB 1 may switch the UE close to NodeB 2 to a frequency different from the available PCC information according to the information included in the “X2 interface establishment request” message transmitted by NodeB 1. In addition, NodeB 2 may configure a maximum transmission power according to the indication of NodeB 2.

In operation 1102, NodeB 2 transmits an “X2 interface establishment response” message to NodeB 1. The “X2 interface establishment response” message includes an identifier of NodeB 2 and cell information on. NodeB 2.

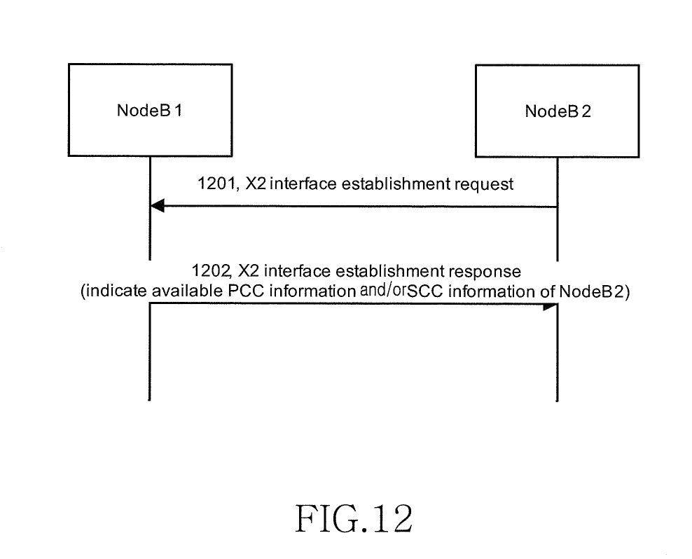

FIG. 12 is a flowchart illustrating the sixth embodiment of the present disclosure. As shown in FIG. 12, in the flow, NodeB 1 is a macro NodeB, NodeB 2 is a Pico NodeB. Based on this, as shown in FIG. 12, the flow may include the following operations.

In operation 1201, NodeB 2 finds an adjacent cell and the adjacent cell belongs to another NodeB (denoted as NodeB 1). NodeB 2 establishes an X2 connection with NodeB 1. In particular, NodeB 2 transmits an “X2 interface establishment request” message to NodeB 1, requesting to establish an X2 interface with NodeB 1.

In operation 1201, the process in which NodeB 2 finds the adjacent cell and determines whether to establish the X2 connection is known in the art and will not be repeated herein.

In operation 1201, the “X2 interface establishment request” message includes an identifier of NodeB 2 and cell information on NodeB 2.

In operation 1202, NodeB 1 transmits an “X2 interface establishment response” message to NodeB 2.

In one option of the sixth embodiment, the “X2 interface establishment response” message further includes the following information: available PCC information and/or available SCC information of NodeB 2.

In the sixth embodiment, the available PCC information and available SCC information included in the “X2 interface establishment response” message are respectively similar to the available PCC information and available SCC information of NodeB 2 in the fifth embodiment and will not be repeated herein.

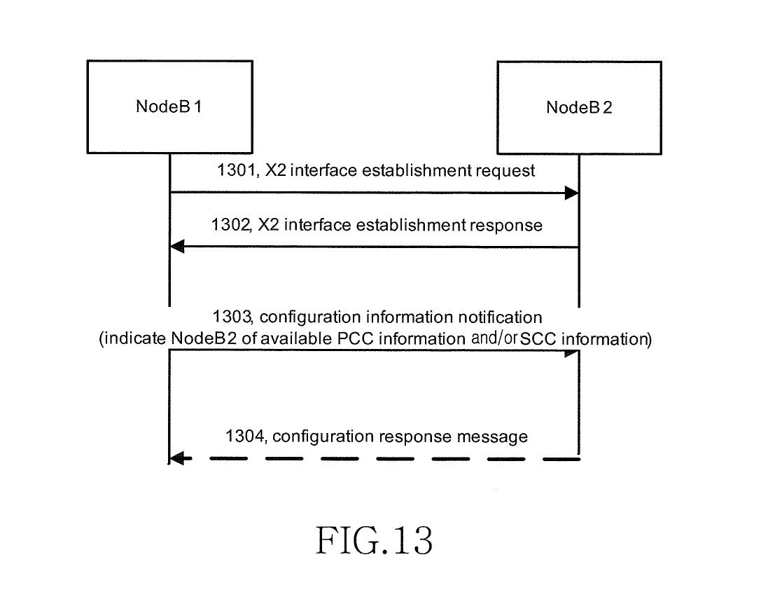

FIG. 13 is a flowchart illustrating the seventh embodiment of the present disclosure. As shown in FIG. 13, in the flow, NodeB 1 is a macro NodeB, and NodeB 2 is a Pico NodeB. Accordingly, as shown in FIG. 13, the flow may include the following operations.

In operation 1301, NodeB 1 finds an adjacent cell and the adjacent cell belongs to another NodeB (denoted as NodeB 2). NodeB 1 establishes an X2 connection with NodeB 1. In particular, NodeB 1 transmits an “X2 interface establishment request” message to NodeB 2, requesting to establish an X2 interface with NodeB 2.

In operation 1301, the process in which NodeB 1 finds the adjacent cell and NodeB 1 and determines whether to establish the X2 connection is known in the art and will not be repeated herein.

In operation 1301, the “X2 interface establishment request” message includes an identifier of NodeB 1 and cell information on NodeB 1.

In operation 1302, NodeB 2 transmits an “X2 interface establishment response” message to NodeB 1. The “X2 interface establishment response” message includes an identifier of NodeB 2 and cell information on. NodeB 2.

In operation 1303, NodeB 1 transmits a “configuration information notification” message to NodeB 2. In some embodiments, the “configuration information notification” message includes the following information: available PCC information and/or available SCC information of NodeB 2.

In the seventh embodiment, the available PCC information of NodeB 2 and the available SCC information of NodeB 2 included in the “configuration information notification” message are respectively similar to the available PCC information and available SCC information of NodeB 2 in the fifth embodiment and will not be repeated herein.

In operation 1304, NodeB 2 transmits a configuration response message to NodeB 1.

In an option of this embodiment, operation 1304 may be omitted, i.e. NodeB 1 transmits the “configuration information notification” message to NodeB 2 to indicate NodeB 2 the available PCC information and the available SCC information of NodeB 2, but NodeB 2 is not required to respond.

When NodeB 1 modifies the available PCC/SCC configuration of NodeB 2, operation 1303 may be used for indicating NodeB 2 the new configuration information, i.e., new available PCC and/or SCC of NodeB 2.

The above four methods are described based on LTE architecture. It is noted that the methods of the present disclosure are also applicable to a UMTS system.

In addition, the above NodeB 1 may be a macro NodeB, Pico NodeB or home NodeB. NodeB 2 may be a macro NodeB, Pico NodeB or home NodeB.

It can be seen from the above technical solution that, in the present disclosure, NodeB 2 does not configure CA for a UE served by NodeB 2 independently. NodeB 2 configures PCC information with little interference for the UE it serves according to the PCC information or PCell information indicated by the adjacent NodeB 1. As such, the interference resulting from the adjacent cell under the multi-carrier configuration to the UE is reduced.

Embodiments of the present invention according to the claims and description in the specification can be realized in the form of hardware, software or a combination of hardware and software.

Such software may be stored in a computer readable storage medium. The computer readable storage medium stores one or more programs (software modules), the one or more programs comprising instructions, which when executed by one or more processors in an electronic device, cause the electronic device to perform methods of the present invention.

Such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

The foregoing descriptions are only preferred embodiments of this disclosure and are not for use in limiting the protection scope thereof. Any changes and modifications can be made by those skilled in the art without departing from the spirit of this disclosure and therefore should be covered within the protection scope as set by the appended claims.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for reducing interference under multi-carrier configuration, comprising:
transmitting, by a first NodeB, to a second NodeB, Primary Component Carrier (PCC) information or Primary cell (PCell) information configured by the first NodeB for a UE served by the first NodeB; and
responding to the first NodeB by the second NodeB.

2. The method of claim 1, further comprising:
referring to the PCC information or PCell information by the second NodeB when configuring the UE.

3. The method of claim 1, wherein the PCC information or PCell information transmitted by the first NodeB is comprised in an X2 interface establishment request or is comprised in a NodeB configuration update message, wherein the NodeB configuration update message is transmitted when a cell of the second NodeB changes.

4. A method for reducing interference under multi-carrier configuration, comprising:
transmitting, by a first NodeB, to a second NodeB, Primary Component Carrier (PCC) information or Primary cell (PCell) information; and
responding to the first NodeB by the second NodeB, and transmitting, by the second NodeB, PCC information or PCell information to the first NodeB.

5. The method of claim 4, wherein the PCC information or PCell information transmitted by the first NodeB is comprised in an X2 interface establishment request, and the PCC information or PCell information transmitted by the second NodeB is comprised in an X2 interface establishment response.

6. The method of claim 4, further comprising:
when configuring a UE, referring to, by the first NodeB or the second NodeB, the PCC information or PCell information indicated by the other NodeB.

7. The method of claim 4, wherein the PCC information comprises one or more carriers, wherein at least one carrier of the one or more carriers is selected as a PCC when the NodeB indicating the PCC information configures Carrier Aggregation (CA) for a UE served by the NodeB.

8. The method of claim 4, wherein the PCell information comprises one or more cells, wherein at least one of the one or more cells is selected as a PCell when the NodeB indicating the PCell information configures CA for a UE served by the NodeB.

9. A method for reducing interference under multi-carrier configuration, comprising:
transmitting, by a first NodeB, coverage area information of a cell of the first NodeB to a second NodeB; and
responding to the first NodeB by the second NodeB.

10. The method of claim 9, wherein the coverage area information transmitted by the first NodeB is comprised in an X2 interface establishment request or is comprised in a NodeB configuration update message, wherein the NodeB configuration update message is transmitted when a cell of the second NodeB changes.

11. The method of claim 9, wherein the first NodeB refers to the information indicated by the second NodeB when configuring a UE.

12. A method for reducing interference under multi-carrier configuration, comprising:
transmitting, by a first NodeB, coverage area information of a cell of the first NodeB to a second NodeB; and
responding to the first NodeB by the second NodeB, and transmitting, by the second NodeB, coverage area information of a cell of the second NodeB to the first NodeB.

13. The method of claim 12, wherein a NodeB refers to information transmitted by an adjacent NodeB when configuring a UE.

14. The method of claim 12, wherein the coverage area information transmitted by the first NodeB is comprised in an X2 interface establishment request, and the coverage area information indicated by the second NodeB is comprised in an X2 interface establishment response.

15. The method of claim 12, wherein the coverage area information comprises: a cell radius, size information of the cell, or a maximum transmission power of the cell.

16. A method for reducing interference under multi-carrier configuration, comprising:
transmitting, by a first NodeB, a high interference indication to a second NodeB when experiencing a high interference from the second NodeB; and
reducing, by the second NodeB, the interference to the first NodeB and responding to the first NodeB.

17. The method of claim 16, wherein the high interference indication comprises one of:
an identifier of a cell affected by the high interference;
frequency information affected by the high interference; and
frequency information affected by the high interference, and an indication whether the frequency is configured by the first NodeB as a Primary Component Carrier (PCC) of a UE served by the first NodeB or an indication whether the cell on the frequency is configured as a PCell of the UE served by the first NodeB.

18. The method of claim 16, wherein reducing the interference to the first NodeB by the second NodeB comprises one of:
decreasing, by the second NodeB, a transmission power of the frequency or the cell affected by the high frequency; and
switching, by the second NodeB, the Primary Component Carrier (PCC) of the UE served by the second NodeB to a frequency having little interference to the first NodeB.

19. A method for reducing interference under multi-carrier configuration, comprising:
transmitting, by a first NodeB, to a second NodeB, available Primary Component Carrier (PCC) information or Secondary Component Carrier (SCC) information; and
responding to the first NodeB by the second NodeB.

20. The method of claim 19, wherein the PCC information or SCC information is expressed by a cell identifier or a cell frequency.

21. The method of claim 19, wherein one of:
the PCC information or SCC information is indicated by an X2 interface establishment request;
the PCC information or SCC information is indicated by an X2 interface establishment response; and
the PCC information or SCC information is indicated by a configuration notification, wherein the configuration notification is transmitted by the first NodeB when the available PCC information or SCC information of the second NodeB changes.

22. The method of claim 19, wherein the second NodeB configures different maximum transmission powers according to the available PCC or SCC indicated by the first NodeB.

23. The method of claim 1, wherein the PCC information comprises one or more carriers, wherein at least one carrier of the one or more carriers is selected as a PCC when the NodeB indicating the PCC information configures Carrier Aggregation (CA) for a UE served by the NodeB.

24. The method of claim 1, wherein the PCell information comprises one or more cells, wherein at least one of the one or more cells is selected as a PCell when the NodeB indicating the PCell information configures CA for a UE served by the NodeB.

25. The method of claim 9, wherein the coverage area information comprises: a cell radius, size information of the cell, or a maximum transmission power of the cell.
